(19) United States
(12) Patent Application Publication
(10) Pub. No.: US 2025/0222847 A1
(43) Pub. Date: Jul. 10, 2025

(54) POP-UP FLOOR SYSTEM FOR VEHICLE

(71) Applicants: Hyundai Motor Company, Seoul (KR); Kia Corporation, Seoul (KR)

(72) Inventors: Seo Heon KIM, Hwaseong-Si (KR); Jae Chun CHO, Hwaseong-Si (KR)

(73) Assignees: Hyundai Motor Company, Seoul (KR); Kia Corporation, Seoul (KR)

(21) Appl. No.: 19/008,034

(22) Filed: Jan. 2, 2025

(30) Foreign Application Priority Data
Jan. 5, 2024 (KR) 10-2024-0002217

(51) Int. Cl. B60N 3/00

(52) U.S. Cl. CPC B60N 3/001

(57) ABSTRACT

A pop-up floor system for a vehicle includes a table configured to be stored in the storage space of the floor, a link assembly configured to interconnect the table and the storage space, to be folded in a stored state of the table in the storage space, and to be deployed when the table is popped up to be moved from the storage space.

### CROSS-REFERENCE TO RELATED APPLICATION

The present application claims priority to Korean Patent Application No. 10-2024-0002217 filed on Jan. 5, 2024, the entire contents of which is incorporated herein for all purposes by this reference.

### BACKGROUND OF THE PRESENT DISCLOSURE

### Field of the Present Disclosure

The present disclosure relates to a pop-up floor system for a vehicle which is configured to form a floor of the vehicle in a normal state and to be popped up, if necessary, to provide a table or a seat, providing convenience to a passenger of the vehicle.

### Description of Related art

Autonomous vehicles are being advanced, beyond simple means of transportation, to a concept capable of utilizing an internal space of a vehicle during transportation.

In such an autonomous vehicle, the driver does not drive the vehicle, and accordingly, passengers in the vehicle may perform various actions. Accordingly, it is necessary for various convenience equipment to be provided in the interior of the vehicle.

In currently-developed vehicles, however, only required devices are provided at required positions within a narrow space, and accordingly, it is difficult to completely cope with various desires of users.

To the present end, in autonomous vehicles, technology for selectively deploying various convenience equipment in a pop-up manner or the like on an indoor floor of a vehicle, selectively enabling the various convenience equipment to be used, is needed.

Meanwhile, vehicles are expanding, beyond simple means of transportation, to a concept of a space usable in daily life.

Accordingly, in nature, a system capable of not only being freely configured in an interior of a vehicle, but also giving wide utility and satisfaction to users through provision of various convenience equipment, is needed.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a pop-up floor system for a vehicle which is configured to form a floor of the vehicle in a normal state and to be popped up, if necessary, to provide a table or a seat, providing convenience to a passenger of the vehicle.

Objects of the present disclosure are not limited to the above-described objects, and other objects of the present disclosure not yet described will be more clearly understood by those skilled in the art from the following detailed description.

In accordance with an aspect of the present disclosure, the above and other objects may be accomplished by the provision of a pop-up floor system for a vehicle including a floor of the vehicle recessed downwards to form a storage space, a table configured to be stored in the storage space of the floor, a link assembly configured to interconnect the table and the storage space, to be folded in a stored state of the table in the storage space, and to be deployed when the table is popped up to be moved from the storage space, and an actuator coupled to the link assembly and configured to provide deployment force to the link assembly.

The storage space may be formed to include an area equal to an area of the table, and an upper surface of the table may form the same plane as an upper surface of the floor in the stored state of the table in the storage space.

The link assembly may be configured in a pair so that a pair of link assemblies is provided at opposite sides of the table, respectively.

The actuator may be a gas spring connected between the pair of link assemblies to provide deployment force to the link assemblies.

The gas spring may simultaneously urge the link assemblies disposed at opposite sides of the table in extension directions thereof, respectively, causing the opposite link assemblies to be simultaneously deployed.

The table may be divided into a plurality of table portions, and each of the table portions may be rotatable with respect to a connection point thereof to the link assembly.

When the table is moved from the storage space while being popped up, the table portions may be rotated 180° to be turned over.

Each of the table portions may have opposite surfaces respectively defined as a floor surface and a usable surface, and may be urged through a spring so that the floor surface is directed upwards.

When each of the table portions is moved from the storage space while being popped up, the table portion may be pulled by a wire so that the usable surface thereof is rotated to be directed upwards.

A seatback may be connected to an upper surface of the table.

The seatback may be rotatable on the table, and when the seatback is overlapped with the table in the stored state of the table in the storage space, an upper surface of the seatback may form the same plane as the floor, and a lower surface of the seatback may face the table.

When the table is moved from the storage space in accordance with pop-up thereof and the seatback is deployed from the table, the lower surface of the seatback may form a seat surface.

In accordance with the pop-up floor system for a vehicle according to an exemplary embodiment of the present disclosure, there is an effect as follows. That is, the pop-up floor system may be configured to form a floor of the vehicle in a normal state and to be popped up, if necessary, to provide a table or a seat, providing convenience to a passenger of the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing a vehicle to which a pop-up floor system for a vehicle according to an exemplary embodiment of the present disclosure;

FIG. 2 and FIG. 3 are views showing a state in which a table of the pop-up floor system according to the exemplary embodiment of the present disclosure is stored;

FIG. 4 and FIG. 5 are views showing a state in which the table of the pop-up floor system according to the exemplary embodiment of the present disclosure is deployed;

FIG. 6, FIG. 7, FIG. 8, and FIG. 9 are views explaining operation of the table of the pop-up floor system according to the exemplary embodiment of the present disclosure;

FIG. 10 is a view explaining a state in which the table of the pop-up floor system according to the exemplary embodiment of the present disclosure is rotated by a wire; and

FIG. 11, FIG. 12 and FIG. 13 are views explaining a pop-up floor system for a vehicle according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, and the same or similar elements are designated by the same reference numerals regardless of the numerals in the drawings and redundant description thereof will be omitted.

In the following description of the exemplary embodiments of the present disclosure, a detailed description of known functions and configurations incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in an exemplary embodiment of the present disclosure.

It will be understood that, although the terms “first”, “second”, etc. may be used herein to describe various elements, these elements should not be limited by these terms. These terms are only used to distinguish one element from another.

Unless clearly used otherwise, singular expressions include a plural meaning.

In the present specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

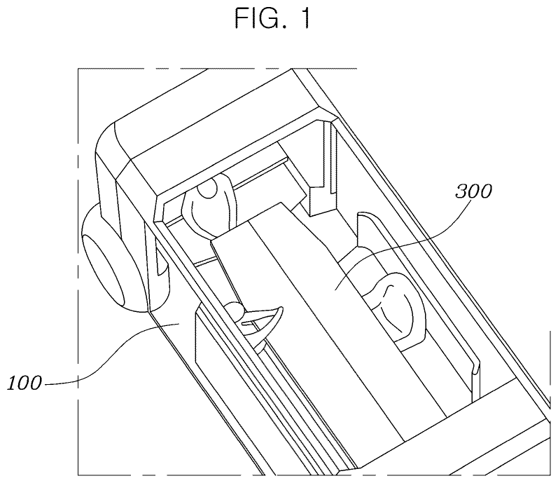

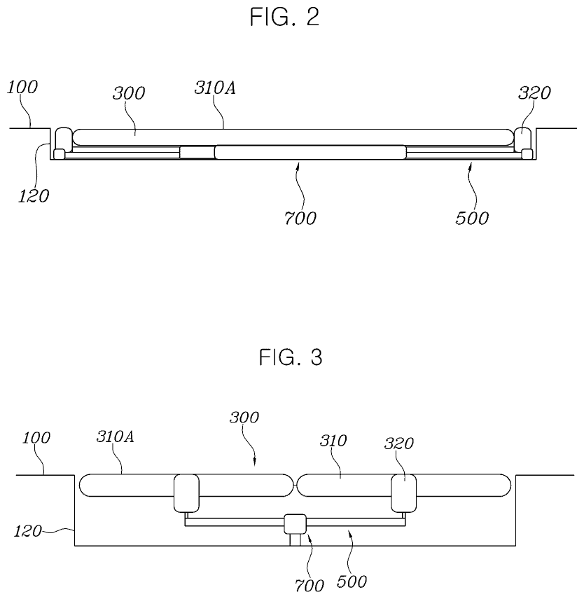

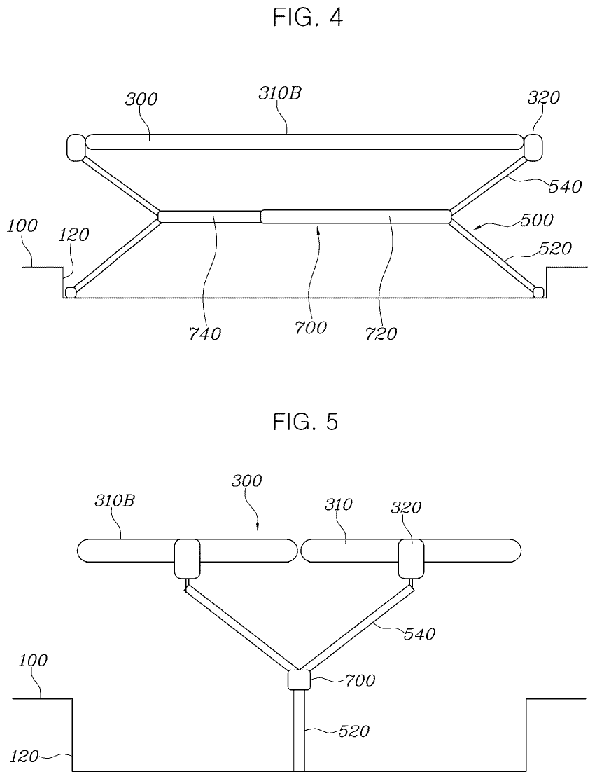

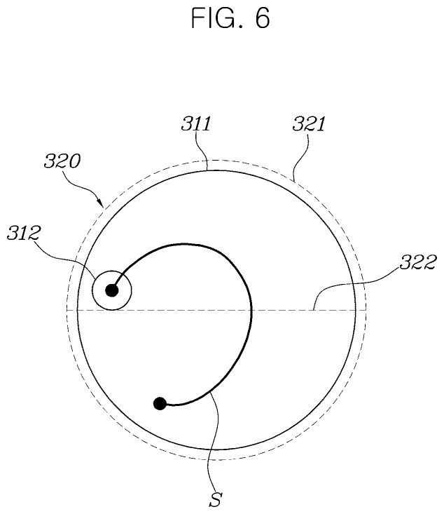

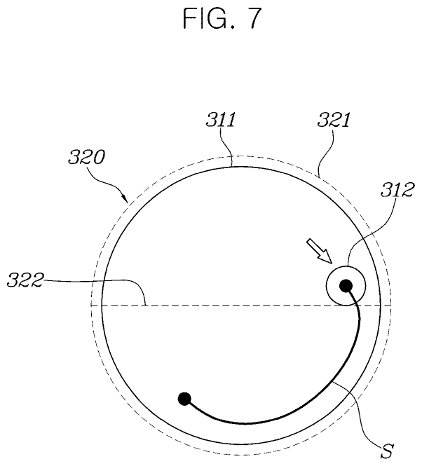

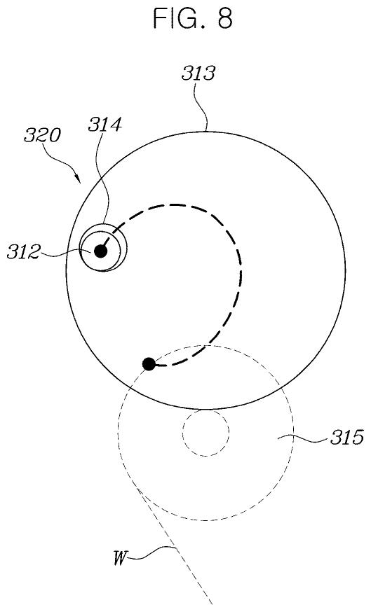

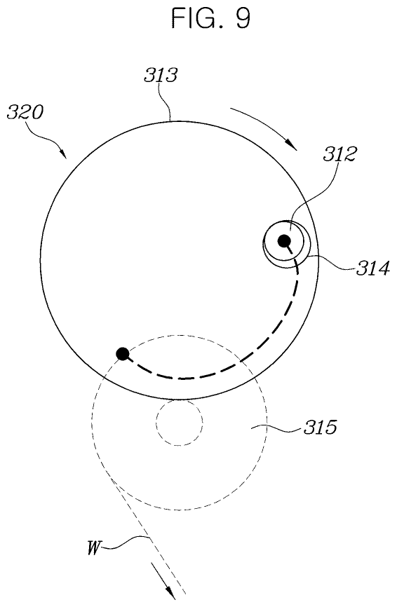

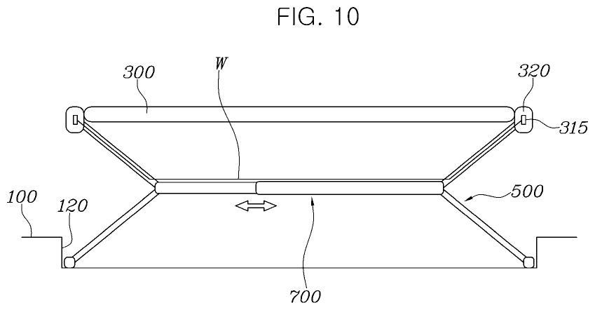

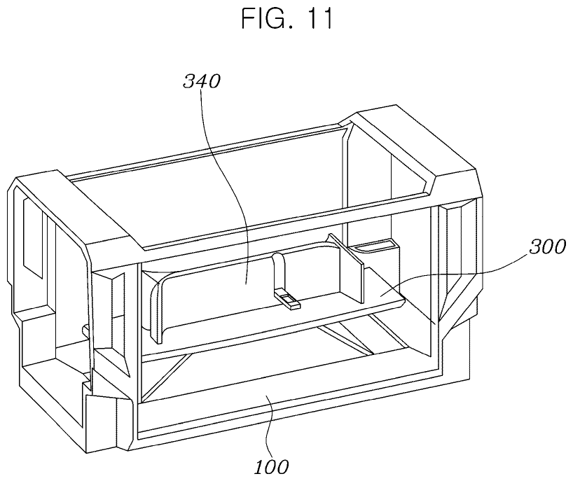

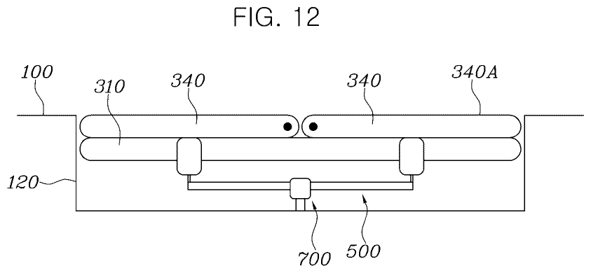

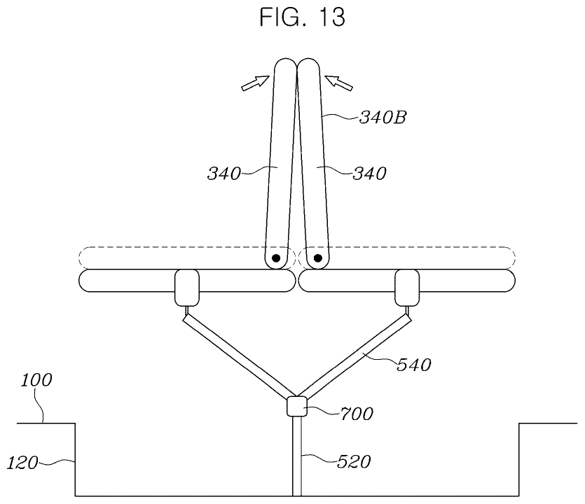

FIG. 1 is a view showing a vehicle to which a pop-up floor system for a vehicle is provided according to an exemplary embodiment of the present disclosure. FIG. 2 and FIG. 3 are views showing a state in which a table of the pop-up floor system according to the exemplary embodiment of the present disclosure is stored. FIG. 4 and FIG. 5 are views showing a state in which the table of the pop-up floor system according to the exemplary embodiment of the present disclosure is deployed. FIG. 6, FIG. 7, FIG. 8, and FIG. 9 are views explaining operation of the table of the pop-up floor system according to the exemplary embodiment of the present disclosure. FIG. 10 is a view explaining a state in which the table of the pop-up floor system according to the exemplary embodiment of the present disclosure is rotated by a wire. FIG. 11, FIG. 12 and FIG. 13 are views explaining a pop-up floor system for a vehicle according to another exemplary embodiment of the present disclosure.

FIG. 1 shows a vehicle to which a pop-up floor system for a vehicle according to an exemplary embodiment of the present disclosure, and FIG. 11 shows a pop-up floor system for a vehicle according to another exemplary embodiment of the present disclosure.

As shown in FIG. 1, a floor 100 is provided at a bottom portion of an interior of the vehicle. In conventional vehicles, a floor thereof includes a fixed panel structure. However, a floor of the present disclosure is provided with a table 300 configured to be deployed in a pop-up manner. The table 300 is stored in the floor 100 in a normal state, but is popped up, if necessary, to perform a table function. Passengers may eat a meal, have a meeting, or read a book for study on the table 300. Thus, a user may store the table 300 in the bottom portion of the vehicle in a normal state to use a widened area of the floor, and may pop up the table 300, if necessary, to use the table 300.

The case of FIG. 11 is the case in which an additional seat is provided through the pop-up floor system as described above. In the instant case, the seat is folded in a normal state so that the seat is stored in the floor 100, and accordingly, performs a floor function, and is popped up, if necessary, to provide an additional seat, similarly to the above-described case. In the instant case, a seat may be additionally used in the vehicle in addition to the existing seat, and when it is unnecessary to use the seat, the seat may be stored in the floor, and accordingly, there is an advantage in that the internal space of the vehicle may be used in a widened state.

First, an exemplary embodiment in which a table is provided through the pop-up floor system according to an exemplary embodiment of the present disclosure will be described. FIG. 2 and FIG. 3 show a state in which the table of the pop-up floor system according to the exemplary embodiment of the present disclosure is stored. FIG. 4 and FIG. 5 show a state in which the table of the pop-up floor system according to the exemplary embodiment of the present disclosure is deployed.

The pop-up floor system according to an exemplary embodiment of the present disclosure includes a floor 100 recessed downwards to form a storage space 120, a table 300 configured to be stored in the storage space 120 of the floor 100, a link assembly 500 configured to interconnect the table 300 and the storage space 120, to be folded in a state in which the table 300 is stored in the storage space 120, and to be deployed when the table 300 is popped up to be moved from the storage space 120, and an actuator configured to provide deployment force to the link assembly 500.

A predetermined portion of the floor 100 is recessed downwards to form the storage space 120. When the table 300 is stored in the storage space 120 in a normal state, there is a boundary between the table 300 and the floor 100. However, the floor 100 is maintained in a flat state on the whole. When it is desired to use the table 300, the table 300 is upwardly unfolded from the storage space 120 to be deployed, and accordingly, may be moved from the storage space 120. Thus, pop-up of the table 300 is achieved. For pop-up thereof, the table 300 is connected to the storage space 120 by the link assembly 500, and the link assembly 500 is deployed by the actuator.

Thus, in a normal state, the link assembly 500 is folded, causing the table 300 to be stored in the storage space 120, and, accordingly, the table 300 forms the floor 100. If necessary, the link assembly 500 is deployed in accordance with operation of the actuator (the seatback 340), and, accordingly, the table 300 is popped up from the storage space 120.

FIG. 2 and FIG. 3 show a state in which the table of the pop-up floor system according to the exemplary embodiment of the present disclosure is stored. In the instant state, both the link assembly 500 and the table 300 are stored in the storage space 120 of the floor 100 in accordance with folding of the link assembly 500. On the other hand, FIG. 4 and FIG. 5 show a state in which the table 300 of the pop-up floor system according to the exemplary embodiment of the present disclosure is deployed. In the instant state, the table 300 is popped up in accordance with deployment of the link assembly 500.

Since the table 300 should be stored in the storage space 120 in the normal state to form a complete structure of the floor 100, the storage space 120 is formed to include the same area as the table 300, and accordingly, an upper surface of the table 300 may form the same plane as an upper surface of the floor 100 in a state in which the table 300 is stored in the storage space 120. Accordingly, in the normal state, the floor 100, which includes a widened area, may be maximally used.

Meanwhile, the link assembly 500 may be configured in a pair so that a pair of link assemblies 500 is provided at opposite sides of the table 300, respectively. Furthermore, the table 300 may be divided into a plurality of table portions 310, and each table portion 310 may rotate with respect to a connection point thereof to a corresponding one of the link assemblies 500.

In detail, the table 300 includes a pair of table portions 310 laterally divided from each other. Each divided table portion 310 may be configured to rotate independently. Since each table portion 310 includes a planar shape, opposite surfaces of the table portion 310 are defined as a floor surface 310A and a usable surface 310B. Accordingly, when the table 300 is stored, the floor surface 310A is directed upwards, whereas, when the table 300 is popped up to be used as a table, each table portion 310 is rotated 180° so that the usable surface 310B thereof is directed upwards. Accordingly, the usable surface 310B may be managed to be clean in the normal state.

When the table portions 310 are changed between a storage state or a deployment state, the table portions 310 should simultaneously rotate. To the present end, each link assembly 500 includes two links, as shown in the drawings. First, an upper V-shaped link 540 is connected to the table portions 310 and a gas spring 700 through hinges. Furthermore, a support link 520, which is disposed under the V-shaped link 540, is connected to a lower portion of the V-shaped link 540 through hinges. An upper end portion of the support link 520 is connected to the V-shaped link 540, and a lower end portion of the support link 520 is pivotally fixed to a bottom portion of the storage space 120 through hinges. Accordingly, when the gas spring 700, which is centrally disposed, extends, the gas spring 700 urges the link assemblies 500 disposed at opposite sides of the gas spring 700 so that the link assemblies 550 are spaced away from each other. Accordingly, the link assemblies 500 are deployed, and, accordingly, the table 300 is popped upwards. The gas spring 700 includes a cylinder 720 and a piston 740 slidably coupled to the cylinder 720.

That is, the actuator may be the gas spring 700 which is connected between the pair of link assemblies 500 to provide deployment force to the link assemblies 500. The gas spring 700 may simultaneously urge the link assemblies 500 disposed at opposite sides thereof in extension directions of the gas spring 700, respectively. Accordingly, the opposite link assemblies 500 are simultaneously deployed.

The gas spring 700 is assembled in a preloaded state so that the gas spring 700 is urged to extend in a normal state. Accordingly, when no external force is applied, the link assemblies 500 are always urged in deployment directions thereof by the gas spring 700. To the present end, when the table 300 is stored in the storage space 120, the table 300 is locked in the storage space 120 of the floor 100 using a separate locker or the like. When the table 300 is to be popped up, the locker is released, and, accordingly, the table 300 is automatically popped up by the pressure of the gas spring 700.

To enable the table portions 310 to rotate while being popped up, the table portions 310 and the link assemblies 500 are interconnected by rotation mechanisms 320. Each rotation mechanism 320 includes a housing 321 provided at a side of a corresponding one of the link assemblies 500, and a stopper formed at an interior of the housing 321. A rotation shaft 311 is inserted into the housing 321. The rotation shaft 311 is formed at an end portion of each table portion 310 corresponding to the rotation mechanism 320. A pole 312 is protruded from the rotation shaft 311. The pole 312 may be brought into contact with the stopper 322 in accordance with 180° rotation thereof, and accordingly, rotation thereof is limited. Furthermore, a spring S is provided between the pole 312 and the stopper 322 to urge the pole 312 to be always disposed at one side of the stopper 322. Accordingly, the pole 312 is always urged to be in a state of FIG. 6, and, accordingly, the table portion 310 is urged so that the floor surface 310A thereof is directed upwards.

When the table portion 310 rotates 180° in a clockwise direction from the state of FIG. 6, the rotation shaft 311 of the table portion 310 is rotated in the interior of the housing 321, as shown in FIG. 7. In in accordance with rotation of the rotation shaft 311, the pole 312 is configured to perform circular motion, and is then brought into contact with an opposite side of the stopper 322, and accordingly, rotation of the rotation shaft 311 is stopped. At the instant time, the useable surface 310B of the table 300 is directed upwards. When external force is removed in the instant state, the table portion 310 is again rotated in a reverse direction in accordance with restoring force of the spring S, and, accordingly, the rotation mechanism 320 may be returned to the state of FIG. 6.

Meanwhile, the usable surface 310B is directed upwards under the condition that the table 300 should rotate simultaneously with pop-up thereof, and the usable surface 310B is protected and the floor surface 310A is exposed under the condition that the table 300 should rotate in a reverse direction simultaneously with downward movement thereof for storage. That is, when upward/downward movement and rotation of the table 300 are simultaneously conducted, there may be user convenience. For the present function, when the table portion 310 is moved from the storage space 120 while being popped up, the table portion 310 is pulled by a wire W, and accordingly, is rotated so that the usable surface 310B thereof is directed upwards.

In detail, the pole 312 is provided at the rotation shaft 311 of the table portion 310, as described above, and a control plate 313 formed with a hole 314 is provided outside the rotation shaft 311. The pole 312 of the table portion 310 is inserted into the hole 314 of the control plate 313. Accordingly, when the control plate 313 rotates, the table portion 310 is also rotated. For rotation of the control plate 313, a reduction gear 315 is connected to the control plate 313, and the wire W is wound around the reduction gear 315. When the wire W is pulled, the reduction gear 315 is rotated, causing the control plate 313 to be rotated. Accordingly, the table portion 310 is rotated 180°.

FIG. 8 shows a state in which the table 300 is stored. When the wire W is pulled in the instant state, the reduction gear 315 is rotated in a counterclockwise direction, as shown in FIG. 9. Accordingly, the control plate 313 is also rotated in a clockwise direction, and, accordingly, the table portion 310 is rotated 180° in the clockwise direction thereof.

Connection of the wire W is achieved as shown in FIG. 10. As shown in FIG. 10, opposite end portions of the wire W are connected to reduction gears 315 disposed at opposite sides, respectively. Furthermore, the wire W is disposed to extend along the link assemblies 500 and the gas spring 700. Accordingly, when the gas spring 700 extends as the table 300 is popped up from a storage state, the opposite end portions of the wire W are pulled to compensate for the extension length of the gas spring 700, rotating the reduction gears 315 disposed at opposite sides.

In accordance with rotation of the reduction gears 315, the table portions 310 are automatically rotated. As the pole 312 is brought into contact with the stopper 322, each table portion 310 is stopped in a state in which the table portion 310 has rotated 180°. In the instant state, the table 300 is temporarily fixed in a state in which the usable surface 310B is directed upwards, by pressure of the gas spring 700 and the stopper 322.

When the user presses the table portion 310, the table portion 310 is moved downwards as the gas spring 700 is compressed. As a result, the spring S rotates the pole 312, and, accordingly, the table portion 310 is also rotated. Subsequently, the table portion 310 is stored, and at the same time, the floor surface 310A is directed upwards. In in accordance with the above-described configuration, the table 300 is automatically rotated in accordance with movement thereof for storage and pop-up movement thereof, and accordingly, it may be possible to protect the usable surface 310B to be clean and to use the table 300 in a clean state.

Meanwhile, FIG. 11 relates to a pop-up floor system for a vehicle according to another exemplary embodiment of the present disclosure. In the instant case, a seatback 340 may be connected to the upper surface of the table 300. When the table 300 is popped up and the seatback 340 is deployed, the table 300 may function as a seat cushion.

In detail, FIG. 12 shows a state in which the table 300 is stored, and FIG. 13 shows a state in which the table 300 is popped up, and accordingly, is changed to a seat. For such a function, the seatback 340 is rotatable on the table 300. When the seatback 340 is overlapped with the table 300 in a state in which the table 300 is stored in the storage space 120, an upper surface 340A of the seatback 340 forms the same plane as the floor 100, and a lower surface 340B of the seatback 340 may face the table 300.

When the table 300 is moved from the storage space 120 in accordance with pop-up thereof and the seatback 340 is deployed from the table 300, the lower surface 340B of the seatback 340 may form a seat surface.

To enable the table 300 to be stored in the storage space 120 in a normal state, the storage space 120 should be formed to include a depth corresponding to the sum of thicknesses of the table 300 and the seatback 340 in an overlapping state. Furthermore, the seatback 340 and the table 300 overlap each other so that seat surfaces thereof face each other, and, accordingly, the seat surfaces may be protected to be clean. Similarly to the previous embodiment, pop-up of the table 300 is achieved by the gas spring 700. After the table 300 is completely popped up, the seatback 340 is rotated in a manual manner or through a motor, and accordingly, provides a complete seat together with the table 300.

After use of the seat, the seatback 340 is folded to overlap with the table 300, and the table 30 is pressed downwards to be stored in the storage space 120. Thus, the floor 100 of the vehicle may be used in a widened state.

The pop-up floor system for a vehicle according to an exemplary embodiment of the present disclosure may be configured to form a floor of the vehicle in a normal state and to be popped up, if necessary, to provide a table or a seat, providing convenience to a passenger of the vehicle.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A pop-up floor system for a vehicle, the pop-up floor system comprising:
a floor of the vehicle recessed downwards to form a storage space in the vehicle;
a table configured to be stored in the storage space of the floor;
a link assembly interconnecting the table and the storage space, and configured to be folded in a stored state of the table in the storage space, and to be deployed from the storage space when the table is popped up; and
an actuator coupled to the link assembly and configured to provide deployment force to the link assembly.

2. The pop-up floor system of claim 1, wherein the storage space is formed to have an area equal to an area of the table, and an upper surface of the table forms the same plane as an upper surface of the floor in the stored state of the table in the storage space.

3. The pop-up floor system of claim 1, wherein the link assembly is in pair and the pair of link assemblies is provided at opposite sides of the table, respectively.

4. The pop-up floor system of claim 3, wherein the actuator is a gas spring connected between the pair of link assemblies to provide deployment force to the link assemblies.

5. The pop-up floor system of claim 4,
wherein the gas spring includes a cylinder and a piston slidably coupled to the cylinder, and
wherein one of the pair of link assemblies is pivotally coupled to the cylinder and another of the pair of link assemblies is pivotally coupled to the piston.

6. The pop-up floor system of claim 4, wherein the gas spring simultaneously urges the link assemblies disposed at the opposite sides of the table in extension directions thereof, respectively, causing the link assemblies to be simultaneously deployed.

7. The pop-up floor system of claim 1, wherein the table includes a plurality of table portions, and each of the table portions is rotatable with respect to a connection point thereof to the link assembly.

8. The pop-up floor system of claim 7, wherein, when the table is moved from the storage space while being popped up, the table portions are rotated 180° to be turned over.

9. The pop-up floor system of claim 7, wherein each of the table portions has opposite surfaces respectively defined as a floor surface and a usable surface, and is urged through an elastic member so that the floor surface is directed upwards.

10. The pop-up floor system of claim 9,
wherein the link assembly is in pair and the pair of link assemblies is provided at opposite sides of the table portions, respectively, and
wherein the pop-up floor system further includes rotation mechanisms coupled to the pair of link assemblies and configured for rotating each of the table portions in a predetermined rotation angle.

11. The pop-up floor system of claim 10, wherein each rotation mechanism includes:
a housing provided at a side of a corresponding one of the link assemblies;
a stopper formed at an interior of the housing;
a rotation shaft formed at an end portion of each table portion; and
a pole protruding from the rotation shaft, wherein the pole is rotatable to contact with the stopper in the predetermined rotation angle, and
the elastic member provided between the pole and the stopper to urge the pole to be disposed at one side of the stopper.

12. The pop-up floor system of claim 11,
wherein each rotation mechanism further includes:
a control plate, wherein the pole is rotatably coupled to an end portion of the control plate; and
a reduction gear engage to the control plate,
wherein a wire is wound around each reduction gear.

13. The pop-up floor system of claim 12, wherein, when each of the table portions is moved from the storage space while being popped up, the table portions are pulled by the wire so that the usable surface of each of the table portions is rotated to be directed upwards.

14. The pop-up floor system of claim 1,
wherein a seatback is connected to an upper surface of the table.

15. The pop-up floor system of claim 14, wherein the seatback is rotatable on the table, and when the seatback is overlapped with the table in the stored state of the table in the storage space, an upper surface of the seatback forms the same plane as the floor, and a lower surface of the seatback faces the table.

16. The pop-up floor system of claim 15, wherein, when the table is moved from the storage space in accordance with pop-up thereof and the seatback is deployed from the table, the lower surface of the seatback forms a seat surface.
